(19) United States
(12) Patent Application Publication
(10) Pub. No.: US 2002/0080756 A1
(43) Pub. Date: Jun. 27, 2002

(54) Wireless network interface

(76) Inventors: Giuseppe Coppola, Vedano Al Lambro (IT); Diego Melpignano, Monza (IT); Petri Heikki Mahonen, Oulu (FI); Mika Juhani Saaranen, Oulu (FI)

Correspondence Address: Philips Electronics North America Corporation, 580 White Plains Road, Tarrytown, NY, 10591, US

(21) Appl. No.: 09/961,981

(22) Filed: Sep. 24, 2001

(30) Foreign Application Priority Data
Sep. 28, 2000 (EP) 00203359.5

(51) Int. Cl. H04Q 7/24

(52) U.S. Cl. 370/338; 370/419; 370/349

(57) ABSTRACT

The present invention provides for a network interface for wireless communications involving a mobile terminal (28), the interface comprising a layered protocol structure, including an Internet protocol responsive link layer (40, 52) arranged to be matched to the wireless link.

The present invention relates to a network interface for a wireless communication involving a mobile terminal, the interface comprising a layered protocol structure.

Mobile terminals, such as, for example, mobile Internet terminals can suffer disadvantages and limitations with regard to their degree of Internet protocol connectivity and which limitations can encompass problems that typically arise in such a wireless link and which include bursty errors and limitations on mobility. The use of such wireless links can also require the inclusion of additional forward error correction techniques, the enforcement of automatic repeat requests, the application of specific protocols or the sending of information in frames having lengths that are required to match the channel conditions.

Previous solutions to such problems have included current WAP and Smart IP technology which is built around specific transport protocols and requires a dedicated proxy arrangement at the network access point which serves to perform protocol translation and also dedicated applications on the mobile terminal. Such current arrangements however suffer disadvantages in that it becomes necessary to change transport protocols such as TCP or UDP.

The present invention therefore seeks to provide a wireless network interface having advantages over such known interfaces and in particular, that can seek to provide optimized IP connectivity without the need to change transport protocols such as TCP or UDP.

According to the present invention there is provided a wireless network interface as defined above and characterized by an Internet protocol responsive link layer arranged to be matched to the wireless link.

The invention is advantageous in providing for a generic wireless interface that can be adopted for use with mobile terminals in, for example, a wireless Internet network and in which the link layer serves to provide for an abstraction of a wireless network interface that can readily be used with different radio standards and that is optimized for IP operation. The link layer advantageously comprises the location at which problems typically associated with the wireless link are arranged to be solved such that transport protocols such as TCP, UDP or RTP can be employed. In this manner, it is not then necessary to change applications. The link layer, which is termed hereinafter the Wireless Adaptation Layer (WAL), is specifically intended to support IP operation due to its relevance to wireless communication and wide use. By means of the present invention, mobile terminals can benefit from a seemingly seamless wireless Internet connectivity. The WAL can therefore be considered as a “smart” wireless network interface that is capable of coping with wireless channel impairments in order to avoid end-to-end performance degradation such as that the TCP layer.

Thus, as a particular advantage, the employment of the WAL of the present invention provides for a configurable wireless network interface for IP applications that is in fact independent of the actual radio interface being used. That is, the WAL defines a generic interface that advantageously provides applications with a common view of the wireless interface and so, as noted above, it is not then dependent upon the specific radio technology being employed.

As a further example, the WAL of the present invention makes it possible to handle traffic classes associated with different quality of service requests.

The features defined in claim 2 advantageously ensure that IP applications can be run on mobile Internet hosts without the need to change transport protocols.

The features defined in claim 3 are advantageous in providing the interface with a common view of the wireless interface and assist the network interface in becoming radio-technology independent.

The features defined in claims 4 and 5 serve to enhance the generic nature of the interface and thus serve to optimize its IP connectivity.

While the feature of claim 6 confirms that the network interface is advantageously optimized for use with TCP packets, the dynamic structure can also advantageously readily accommodate, for example, UDP and RTP protocols.

The feature defined in claim 7 further assists in providing for a readily adaptable generic wireless network interface.

The features defined in claims 8-10 relate to a further advantage which seeks to prevent channel impairments that might otherwise arise in the wireless link from propagating to higher layers within the interface structure such as the TCP layer which might then erroneously identify a situation of network congestion and which would then reduce throughput.

As such, it should be appreciated that the WAL of the present invention provides for a frame-work serving to accommodate all possible algorithms that are required by mobile hosts for solving problems arising in relation to, for example, wireless Internet connectivity.

It should also be appreciated that the WAL is advantageously arranged to perform a set of intelligence functions such as, for example, a scheduling policy on outgoing packets that is able to match the quality of service demands coming from applications to the current wireless channel conditions. The present invention allows, for example, for the downloading of a quality of service module that serves to queue packets in separate queues and then transmits the packets according to scheduling algorithms that operate in the manner responsive to channel conditions. In this example, the quality of service module would serve to provide improved wireless link utilization while seeking not to favor any particular one or more applications seeking access to the wireless link under conditions of contention. Other such intelligent functions performed within the WAL can comprise header compression and data segmentation and reassembly.

The invention is described further hereinafter, by way of example, with reference to the accompanying drawings in which:

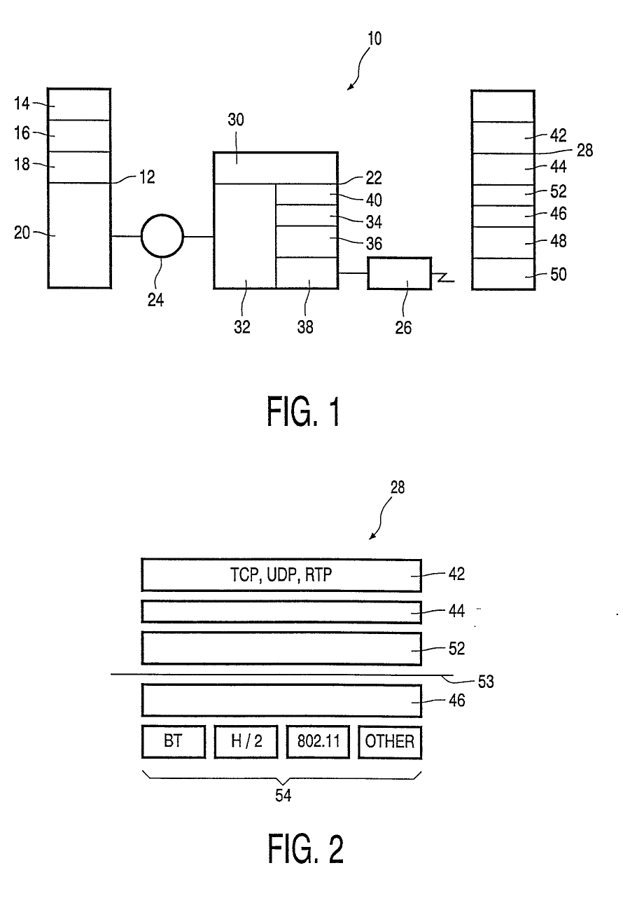

FIG. 1 is a schematic block diagram of a wireless Internet architecture employing an embodiment of the present invention;

FIG. 2 is a block diagram of the functionality of the embodiment of the present invention as found in the architecture of FIG. 1; and

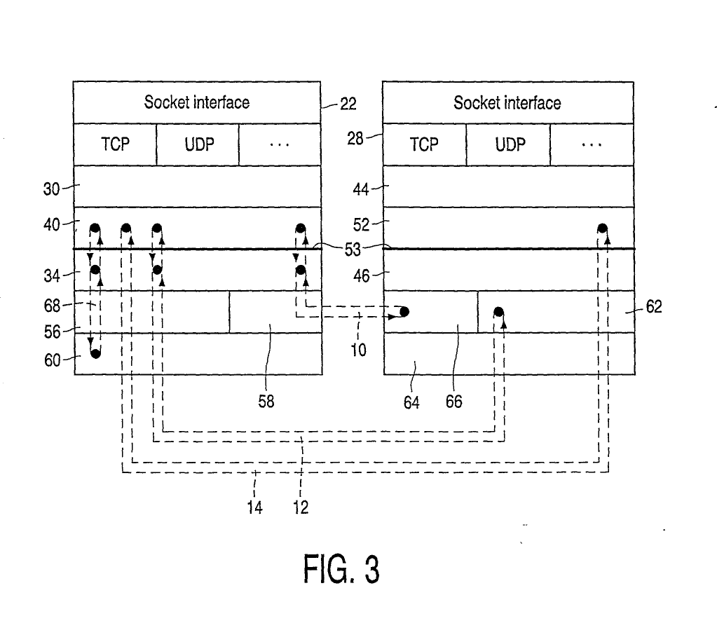

FIG. 3 illustrates how the network interface layer embodying the present invention can be met so as to comply with the Bluetooth communication standard.

Turning first to FIG. 1, there is illustrated an embodiment of the concept of the present invention in which a WAL is provided for use in an Internet network allowing for wireless access.

The wireless Internet architecture 10 illustrated in FIG. 1 comprises a fixed host 12 offering a layered structure comprising, in descending order, an application layer 14, a TCP layer 16, and IP layer 18 and a network interface connection layer 20. The fixed host 12 is connected to a network access point 22 by means of a TCP/IP Internet connection 24 and the access point 22 allows for wireless connection by means of a wireless connector 26 to a mobile terminal 28.

Returning to the access point 22, a layered structure is also provided therein and which comprises an IP layer 30, a network interface connection layer 32 for connection to the TCP/IP Internet connection 24 and also a logical link control (LLC) layer 34, a medium access control (MAC) layer 36 and a wireless connection layer 38 for connection to the wireless connector 26.

In accordance with an important aspect of the illustrated embodiment of the present invention, the access point 22 also includes a link layer embodying the present invention and which is identified as a wireless adaption layer (WAL) 40.

Turning now to the mobile host, the layered structure here comprises a TCP layer 42, an IP layer 44, and LLC layer 46, a MAC layer 48 and a wireless connector layer 50 for a wireless communication with the wireless connector 26 of the access point 22. Again, in accordance with the illustrated embodiment, the mobile terminal 22 includes a WAL 52 within its layered structure.

In accordance with the illustrated embodiment of the present invention, the WAL layers 40, 52 within the access point 22 and mobile terminal 28 are arranged to perform processing such as header compression, IP snooping, intelligent packet scheduling and segmentation and reassembly and also seeks to solve the problems that arise in relation to the wireless link. As will be appreciated, the WAL layers 40 and 52 are located between the respective IP layers and LLC layers within the access point 22 and mobile terminal 28 and such location advantageously serves to prevent the propagation of channel impairments that might arise in the wireless link into high layers of the layered structure such as, with reference to the mobile terminal 28, the TCP layer 42.

When a particular functionality is already present within the specific radio interface, the relevant generic request needs simply to be translated whereas, in other cases, it is advantageously implemented at the WAL level 40, 52 or in the LLC layer 34, 46, once an appropriate software module has been loaded as a dynamic plug-in. Such features are further illustrated with reference to FIG. 3 as discussed below.

While the WAL is specifically optimized for use with TCP packets, it advantageously exhibits a dynamic structure which can also accommodate, for example, UDP and RTP. Also, the modular design advantageously enables additional features to be added as plug-ins so as to achieve appropriate intelligent functions such as, for example, a scheduling policy of outgoing packets that is able to match the quality of service demands arising from applications, to the particular wireless channel condition.

Turning now to FIG. 2, it should be appreciated that the WAL of the present invention offers a solution different from that proposed by previous approaches in that it serves to provide for an IP-aware link layer that is matched to the wireless link. FIG. 2 illustrates by means of a block diagram part of the mobile terminal 28 employed within the architecture of FIG. 1 and which clearly illustrates the location of the WAL 52 between the IP 44 and LLC 46. A particular advantage of the WAL 52 of the present invention is that, since it is arranged to operate below the IP layer 44 in the protocol stack illustrated in FIGS. 1 and 2, existing transport protocols such as, TCP, UDP and RTP can be employed as illustrated with reference to the layer 42 of FIG. 2. This advantageously determines that specific applications running on the mobile terminal 28 need not then be changed.

The WAL is arranged to be wireless-interface independent and so not dependent upon the particular radio technology employed. In the present illustrated example, such independence is achieved by employing an IEEE 802.2 protocol layer 53 between the WAL 52 and LLC 46 for signaling purposes as described further below.

Also illustrated within FIG. 2 is a radio technology layer 54 which serves to illustrate that the WAL of the present invention can in fact be employed with different radio technology platforms such as the Bluetooth (BT), HIPERLAN-2 (H/2) and the IEEE 802.11 platform and indeed others. As will be appreciated, these platforms exhibit specific differences with regard to, for example, available bit rates, and a degree of connectivity. While the respective MAC and LLC requirements are also quite different in each case.

The functionality of the WAL 52 serves to configure the appropriate algorithms to be applied to IP packets in order to boost the performance of the particular transport protocol in the wireless network itself. The WAL 52 is arranged to perform IP packet classification and is then able to discriminate between different classes of communication traffic. Then, each class receives a specific service with a pre-defined, user-configurable degree of quality. As mentioned above, the WAL 52 is radio-technology-platform independent.

In the LLC 46, the generic functions are identified by the WAL 52 are mapped to platform specific functionality and this part of the structure as illustrated in FIGS. 1 and 2 is in fact radio dependent but is arranged to communicate to the WAL 52 through a standard interface. Such an interface that enables the WAL 52 to exchange commands, as well as data packets with the particular radio platforms comprises the layer 53 in FIG. 2 and, as noted, is advantageously arranged to be compliant with the IEEE 802.2 standard which therefore assists with the division of the layered structured into radio-technology dependent and radio-technology independent parts of the structure.

Turning now to FIG. 3 there is illustrated the mapping of the WAL embodying the present invention in a Bluetooth communication scenario.

FIG. 3 again illustrates the layered structure arising within the access point 22 and mobile terminal 28 and also serves to illustrate the socket interfaces and possible choice of transport protocol in layers above the respective Internet Protocol layers 30, 44. In addition to employing respective Bluetooth LLCs 34 and 46, the access point 22 and mobile terminal 28 also include Bluetooth logical link control adaption protocol layers 56, 62, Bluetooth link management protocol layers 58, 66 and Bluetooth base band layers 60, 64. Also illustrated is the IEEE 802.2 compliant interface 53 between the WAL and LLC layers within both the access point 22 and the mobile terminal 28.

Turning now to the signaling arrangements of the mapped structures, three different types of signal class can be identified and are illustrated.

First there is illustrated requests 68 from the WAL 40 within the access point 22 that can be resolved locally. Secondly, there are requests 70, 72 that employ existing signaling protocols, and thirdly, there are signals 74 that employ newly defined signaling protocols and that are carried in IEEE 802.2 compliant frames and that are interpreted within the WAL 52 within the mobile terminal 28.

In further detail, a request from the WAL 40 is sent in the form of an IEEE 802.2 compliant frame to the LLC layer 34. If this request can be satisfied by means of functionality that already exists within the lower layers of the structure illustrated in FIG. 3, then the appropriate function is deployed. In further detail, in a situation where a mobile terminal 28 issues a request to establish a connection to another terminal within the Bluetooth scenario, then the generic request is translated into a specific protocol message in accordance with the line management protocol. If the request from the WAL cannot be satisfied with the existing functionality within the structure, a software module that can implement the required algorithm is then to be loaded and executed such as would be the case if the mobile terminal was to achieve a particular quality of service my means of a specific scheduling algorithms.

The modular structure of the present invention advantageously assists in the downloading of such a quality of service module. In other cases, the WAL could readily request extra error protection against transmission errors.

As a further possibility, it may be the case that a new signaling arrangement between the WAL layers is required and, in this case, the IEEE 802.2 frame is generated by the WAL of the present invention on one host can be sent to WAL on the other host so that a specific protocol is implemented. Such an arrangement can prove particularly advantageous for supporting host micro-mobility, the preparation for hand-off procedures and also quality of service reporting activities.

It will therefore be appreciated that the WAL of the present invention provides for a frame work serving to accommodate all likely algorithms that are necessary for mobile hosts to solve problems and issues arising in relation to wireless Internet connectivity. Of course, the applicability of the WAL of the present invention is not limited to a wireless LAN scenario such as that described above but can be employed with any mobile terminal such as mobile phones having Internet access.

It should also be appreciated that the present invention is not necessarily intended for adoption in a cellular access network and so has no particular relevance with regard to current GSM infrastructures. As noted, the WAL concept of the present invention generally applies, but is not limited to, wireless local area networks such as those based on IEEE 802.11, Bluetooth or HIPERLAND-2 platforms and, as illustrated above, the WAL can be arranged to run on the network access point and the mobile terminal. However, it is also possible that the WAL need only be provided at the access point. As discussed above, the present invention therefore advantageously provides for a configurable wireless network interface for IP applications that is independent of the radio interface actually being employed. Within the WAL framework, new protocols can be developed as discussed above and that serve to boost the performance of the IP applications.

A particular example is that of a WAL running on a LAN access point that is serving two terminals by using the IEEE 802.11 standard, wherein the first terminal has two applications running: a Web session and a voice-over-IP application, while the second terminal has a real-time application running (such as Real audio or Internet Videoconference) and is in the same position as the other mobile.

In this case, the WAL at the access point would serve to accept IP packets that must be transmitted to both terminals with different service requirements. Whenever an IP packet arrives at WAL it must be classified and served differently. Packets belonging to the two real-time applications (VoIP and Real audio) would be treated in the same way since the two mobile terminals experience similar wireless link conditions. Therefore such packets would be sent to a Forward Error Correction module in order to avoid retransmissions. Conversely, packets belonging to the Web session would not be sent to the FEC module, but would flow through a “snoop” module that monitors TCP acknowledgement packets and performs local retransmissions between the access point and the mobile terminal.

The output of the two modules is delivered to a QoS module that transmits packets according to the specific requests of the applications. In this case, packets belonging to the real-time applications would be privileged.

In the above example, the two real-time applications (that use a UDP-based protocol) are classified in the same way and serviced accordingly, whereas the Web application (based on HTTP/TCP protocols) is treated in a different way.

Further, the invention seeks to provide a differentiated service to IP applications with similar characteristics and so all IP packets belonging to the applications having, for example, stringent end-to-end delay constraints would then be arranged to travel across the same chain of modules. In this manner, the invention is not concerned with individual data flows but rather, flow aggregates sharing common characteristics and which are to be served in the most appropriate way having regard to such characteristics.

1. A network interface for wireless communications involving a mobile terminal (28), the interface comprising a layered protocol structure, characterized by an Internet protocol responsive link layer (40, 52) arranged to be matched to the wireless link.

2. An interface as claimed in claim 1, and arranged for solving problems associated with the wireless link at the link layer (40, 52).

3. An interface as claimed in claim 1 or 2, comprising a generic interface arranged to be independent of the radio interface employed within the wireless network.

4. An interface as claimed in claim 1, 2 or 3, wherein the link layer (40, 52) is arranged to accept flow of IP packets generated by different applications and to handle the IP packets responsive to wireless channel limitations.

5. An interface as claimed in any one of claims 1-4, wherein the link layer (40, 52) has a dynamic structure for accommodating a plurality of transport protocols.

6. An interface as claimed in claim 5, and arranged for operation with the Transport Control Protocol.

7. An interface as claimed in any one of claims 1-6, wherein the link layer (40, 52) is of a modular form arranged to receive plug-ins embodying additional functional features.

8. An interface as claimed in any one of claims 1-7, wherein the link layer (40, 52) is arranged for operation below an IP layer (30, 44) within a protocol stack.

9. An interface as claimed in any one of claims 1-8, wherein the link layer (40, 52) is provided at the access point (22) of the wireless network and a mobile terminal (28).

10. An interface as claimed in any one of claims 1-9, wherein the link layer (40, 52) is arranged for the configuration of algorithms to be applied to IP packets.

11. An interface as claimed in any one of claims 1-10, wherein the link layer (40, 52) comprises a computer program product.

12. A computer program product for use in a network interface for wireless communications involving a mobile terminal, and comprising an Internet protocol responsive link controller matched to the wireless link.

13. A mobile terminal (28) having a network interface for wireless communications, the interface comprising a layered protocol structure, characterized by an Internet protocol responsive link layer (40, 52) arranged to be matched to the wireless link.
